(19) United States
(12) Patent Application Publication
(10) Pub. No.: US 2023/0163393 A1
(43) Pub. Date: May 25, 2023

(54) CELL-TO-PACK FIXATION SYSTEM AND METHOD

(71) Applicant: Polestar Performance AB, Göteborg (SE)

(72) Inventors: Martin Andersson, Gothenburg (SE); Stefan Holmstrom, Gothenburg (SE); Johan Janers, Gothenburg (SE); Robert Wassmur, Gothenburg (SE); Sanjeev Sharma, Coventry (GB); Chris Staunton, Maidenhead (GB); Anders Lundberg, Gothenburg (SE)

(21) Appl. No.: 17/531,578

(22) Filed: Nov. 19, 2021

(51) Int. Cl. H01M 50/249; H01M 10/42; H01M 10/625; H01M 50/204

(52) U.S. Cl. CPC H01M 50/249; H01M 10/425; H01M 10/625; H01M 50/204; H01M 2220/20; H01M 2010/4271

(57) ABSTRACT

An electric vehicle battery pack including a battery tray, a plurality of individual battery cells, one or more bands surrounding at least a portion of the plurality of individual battery cells, thereby banding the portion of individual battery cells together in a discrete cluster, and a bracket assembly configured to operably couple the banded discrete cluster to the battery tray.

### TECHNICAL FIELD

The present disclosure relates generally to battery systems for electric vehicles, and more particularly to fixation systems and methods for securing individual battery cells within a battery pack, with the elimination of enclosure modules surrounding the individual battery cells, thereby resulting in a more energy efficient, and more energy dense battery pack.

### BACKGROUND

Electric vehicles are becoming increasingly popular as consumers look to decrease their environmental impact and improve air quality. Instead of a traditional internal combustion engine (ICE), electric vehicles include one or more motors, powered by a rechargeable battery pack. Conventional electric vehicle battery packs are typically constructed of multiple components, including a plurality of battery modules, electrical current transmission systems, temperature control systems, safety systems, battery management systems (BMS) and structural supports. The battery modules, which are often constructed by a third party supplier, generally include an enclosure containing a plurality of battery cells, which act as galvanic cells when being discharged by converting chemical energy to electrical energy, and electrolytic cells when being recharged by converting electrical energy to chemical energy. Although there are certain advantages to the use of battery modules (e.g., defective modules can be removed and replaced), the enclosure portion of the modules generally represent a non-value added component, occupying valuable space within the battery pack.

More recently, efforts have been made to eliminate the module enclosures by integrating the battery cells directly into the battery pack, commonly referred to as cell-to-pack (CTP) technology, resulting in a more energy efficient, and more energy dense battery pack. According to a recent press release by Contemporary Amperex Technology Co., Limited (CATL), using CTP technology can result in a battery pack with an increase in mass energy density by 10-15%, an improvement in volume utilization efficiency by 15-20%, and a reduction in the amount of parts for battery packs by 40%. Moreover, the resulting CTP battery can increase the system energy density from 180 Wh/kg to more than 200 Wh/kg. See https://www.catl.com/en/news/468.html. See also US Patent App. No. 2019/0312251, disclosing an approach to CTP battery construction, the contents of which are incorporated by reference herein to the extent that the contents do not conflict with this disclosure.

Although such efforts have proved useful for their intended purpose, further improvements in energy density and efficiency are desirable. In particular, with the elimination of the module enclosures, the individual cells must still be secured within the battery pack. Securing the individual battery cells in a manner that doesn't take up a lot of space, and doesn't require a lot of effort during construction remains a persistent problem. The present disclosure addresses these concerns.

### SUMMARY OF THE DISCLOSURE

Embodiments of the present disclosure provide cost-efficient devices and methods of securely fastening clusters of individual battery cells and cell voltage temperature nodes within a battery tray, in a manner which tends to reduce the overall number of components necessary for construction of the battery pack. In some embodiments, coupling of the individual battery cells and cell voltage temperature nodes within the battery tray can be completed without the use of additional fasteners, adhesives, or the like, thereby reducing the amount of labor and materials required for assembly of the battery pack.

One embodiment of the present disclosure provides an electric vehicle battery pack including a battery tray, a plurality of individual battery cells, one or more bands surrounding at least a portion of the plurality of individual battery cells, thereby banding the portion of individual battery cells together in a discrete cluster, and a bracket assembly configured to operably couple the banded discrete cluster to the battery tray.

In one embodiment, the electric vehicle battery pack comprises a total of eight rows of banded individual battery cells. In one embodiment, the discrete clusters each include an end plate configured to absorb stress exerted upon the discrete cluster. In one embodiment, the bracket assembly is operably coupled to the battery tray by at least one of a threaded fastener, rivet, or adhesive. In one embodiment, the bracket assembly is integrally formed within the battery tray. In one embodiment, the bracket assembly is mounted on at least one of a horizontal or vertical surface within the battery tray. In one embodiment, the bracket assembly includes one or more resilient portions configured to temporarily deform to enable coupling of the discrete cluster to the bracket assembly, and then to spring back to an un-deformed position to inhibit inadvertent decoupling of the bracket assembly from the discrete cluster.

In one embodiment, the one or more bands surrounding at least a portion of the plurality of individual battery cells includes a post, stud or protrusion configured to matingly engage with a portion of the bracket assembly. In one embodiment, the bracket assembly comprises at least one lateral cross band configured to at least partially traverse around a lateral portion of the discrete cluster of banded individual cells. In one embodiment, the bracket assembly is configured to aid in maintaining a desired spacing between two or more discrete clusters of banded individual battery cells.

Another embodiment of the present disclosure provides an electric vehicle battery pack, including a battery tray, at least one cell voltage temperature node, and a bracket assembly configured to operably couple the at least one cell voltage temperature node to the battery tray.

In one embodiment, the bracket assembly is operably coupled to the cell voltage temperature node by at least one of a threaded fastener, rivet, or adhesive. In one embodiment, the bracket assembly includes one or more resilient portions configured to temporarily deform to enable coupling of the discrete cell voltage temperature node to the bracket assembly, and then to spring back to an un-deformed position to inhibit inadvertent decoupling of the bracket assembly from the cell voltage temperature node. In one embodiment, the bracket assembly includes at least one post configured to be received within a corresponding aperture of the cell voltage temperature node. In one embodiment, the bracket assembly includes at least one channel configured to receive a portion of the cell voltage temperature node. In one embodiment, the cell voltage temperature node is operably coupled to the bracket assembly without the use of additional fasteners or adhesives. In one embodiment, the cell voltage temperature node is operably coupled to the bracket assembly with the aid of a frictional interfering fit.

Yet another embodiment of the present disclosure provides an electric vehicle battery pack, including a battery tray, a plurality of individual battery cells, one or more bands surrounding at least a portion of the plurality of individual battery cells, thereby banding the portion of individual battery cells together in a discrete cluster, at least one cell voltage temperature node for each banded discrete cluster, a battery cell bracket assembly configured to operably couple the banded discrete cluster to the battery tray, and a cell voltage temperature node bracket assembly configured to operably couple the at least one cell voltage temperature node to the battery tray.

In one embodiment, the electric vehicle battery pack comprises a total of eight rows of banded individual battery cells. In one embodiment, the battery cell bracket assembly and cell voltage temperature node bracket assembly are integrally formed within the battery tray.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1A is a perspective view depicting a portion of a battery pack employing CTP technology, in accordance with an embodiment of the disclosure.

FIG. 1B is a perspective view of a sealed battery pack employing CTP technology, positionable within an electric vehicle, in accordance with an embodiment of the disclosure.

FIG. 2A is a perspective view depicting a cluster or bundle of individual battery cells banded together, in accordance with an embodiment of the disclosure.

FIG. 2B is a perspective view depicting a cluster of individual battery cells operably coupled to a portion of a battery tray, in accordance with an embodiment of the disclosure.

FIG. 3A is a perspective view depicting a bracket assembly within a battery tray with the bracket assembly of FIG. 2A, in accordance with an embodiment of the disclosure.

FIG. 3B is a perspective view depicting a cluster of individual battery cells operably coupled to a portion of the battery tray with the bracket assembly of FIG. 3A, in accordance with an embodiment of the disclosure.

FIG. 4A is a perspective view depicting a pair of bracket assemblies, in accordance with an embodiment of the disclosure.

FIG. 4B is a perspective view depicting the bracket assemblies of FIG. 4A positioned within a battery tray, in accordance with an embodiment of the disclosure.

FIG. 4C is a perspective view depicting a cluster of individual battery cells operably coupled to a portion of the battery tray with the bracket assemblies of FIG. 4A, in accordance with an embodiment of the disclosure.

FIG. 5A is a perspective view depicting a bracket assembly, in accordance with an embodiment of the disclosure.

FIG. 5B is a perspective view depicting the bracket assembly of FIG. 5A positioned within a battery tray, in accordance with an embodiment of the disclosure.

FIG. 5C is a perspective view depicting a cluster of individual battery cells operably coupled to a portion of the battery tray with the bracket assembly of FIG. 5A, in accordance with an embodiment of the disclosure.

FIG. 6A is a perspective view depicting a bracket assembly, in accordance with an embodiment of the disclosure.

FIG. 6B is a perspective view depicting the bracket assembly of FIG. 6A positioned within a battery tray, in accordance with an embodiment of the disclosure.

FIG. 6C is a perspective view depicting a cluster of individual battery cells operably coupled to a portion of the battery tray with the bracket assembly of FIG. 6A, in accordance with an embodiment of the disclosure.

FIG. 7 is a cross-sectional view depicting a bracket assembly operably coupling a cluster of individual battery cells within a battery tray, in accordance with an embodiment of the disclosure.

FIG. 8A is a perspective view depicting a bracket assembly, in accordance with an embodiment of the disclosure.

FIG. 8B is a perspective view depicting the bracket assembly of FIG. 8A positioned within a battery tray, in accordance with an embodiment of the disclosure.

FIG. 8C is a perspective view depicting a cluster of individual battery cells operably coupled to a portion of the battery tray with the bracket assembly of FIG. 8A, in accordance with an embodiment of the disclosure.

FIG. 9A is a perspective view depicting a of bracket assembly, in accordance with an embodiment of the disclosure.

FIG. 9B is a perspective view depicting the bracket assembly of FIG. 9A positioned within a battery tray, in accordance with an embodiment of the disclosure.

FIG. 9C is a perspective view depicting a cluster of individual battery cells operably coupled to a portion of the battery tray with the bracket assembly of FIG. 9A, in accordance with an embodiment of the disclosure.

FIG. 10A is a perspective view depicting a bracket assembly positioned within a battery tray, in accordance with an embodiment of the disclosure.

FIG. 10B is a close-up view of the bracket assembly of FIG. 10A, in accordance with an embodiment of the disclosure.

FIG. 11A is a perspective view depicting a bracket assembly, in accordance with an embodiment of the disclosure.

FIG. 11B is a perspective view depicting the bracket assembly of FIG. 11A positioned on a horizontal surface within a battery tray, in accordance with an embodiment of the disclosure.

FIG. 11C is a perspective view depicting the bracket assembly of FIG. 11A positioned on a vertical surface within a battery tray, in accordance with an embodiment of the disclosure.

FIG. 12 is a perspective view depicting a channel interacting with the post of a cluster of individual battery cells, thereby securing the cluster of individual battery cells within a battery tray, in accordance with an embodiment of the disclosure.

FIG. 13A is a perspective view depicting a bracket assembly positioned within a battery tray, in accordance with an embodiment of the disclosure.

FIG. 13B is a perspective view depicting a cluster of individual battery cells operably coupled to a portion of the battery tray with the bracket assembly of FIG. 13A, in accordance with an embodiment of the disclosure.

FIG. 14A is a perspective view depicting a bracket assembly, in accordance with an embodiment of the disclosure.

FIG. 14B is a perspective view depicting a cluster of individual battery cells operably coupled to a portion of the battery tray with the bracket assembly of FIG. 14A, in accordance with an embodiment of the disclosure.

FIG. 15A is a top view depicting a multi-row cluster of individual battery cells operably coupled to a portion of the battery tray with a bracket assembly, in accordance with an embodiment of the disclosure.

FIG. 15B is a profile view depicting the multi-row cluster of FIG. 15A, in accordance with an embodiment of the disclosure.

FIG. 16A is a top view depicting a single row cluster of individual battery cells operably coupled to a portion of the battery tray with a bracket assembly, in accordance with an embodiment of the disclosure.

FIG. 16B is a profile view depicting the single row cluster of FIG. 16A, in accordance with an embodiment of the disclosure.

FIG. 17A is a perspective view depicting a bracket assembly positioned within a battery tray, in accordance with an embodiment of the disclosure.

FIG. 17B is a perspective view depicting a cluster of individual battery cells operably coupled to a portion of the battery tray with the bracket assembly of FIG. 17A, in accordance with an embodiment of the disclosure.

FIG. 18A is a perspective view depicting a bracket assembly, in accordance with an embodiment of the disclosure.

FIG. 18B is a perspective view depicting the bracket assembly of FIG. 18A positioned within a battery tray, in accordance with an embodiment of the disclosure.

FIG. 18C is a perspective view depicting a cluster of individual battery cells operably coupled to a portion of the battery tray with the bracket assembly of FIG. 18A, in accordance with an embodiment of the disclosure.

FIG. 19A is a perspective view depicting a bracket assembly, in accordance with an embodiment of the disclosure.

FIG. 19B is a perspective view depicting a cluster of individual battery cells operably coupled to a portion of the battery tray with the bracket assembly of FIG. 19A, in accordance with an embodiment of the disclosure

FIG. 20A is a perspective view depicting a bracket assembly positioned within a battery tray, in accordance with an embodiment of the disclosure.

FIG. 20B is a perspective view depicting a cluster of individual battery cells operably coupled to a portion of the battery tray with the bracket assembly of FIG. 20A, in accordance with an embodiment of the disclosure.

FIGS. 21A-B are a perspective views depicting a bracket assembly positioned within a battery tray, in accordance with an embodiment of the disclosure.

FIG. 21C is a perspective view depicting a cluster of individual battery cells operably coupled to a portion of the battery tray with the bracket assembly of FIG. 21A, in accordance with an embodiment of the disclosure.

FIGS. 22A-B are profile views depicting a bracket assembly operably coupling a cluster of individual battery cells to a battery tray, in accordance with an embodiment of the disclosure.

FIG. 23A is a perspective view depicting a CVTN bracket assembly, in accordance with an embodiment of the disclosure.

FIG. 23B is a perspective view depicting the bracket assembly of FIG. 23A operably coupled to a CVTN, in accordance with an embodiment of the disclosure.

FIG. 24A is a perspective view depicting a CVTN bracket assembly, in accordance with an embodiment of the disclosure.

FIG. 24B is a perspective view depicting the bracket assembly of FIG. 24A operably coupled to a CVTN, in accordance with an embodiment of the disclosure.

FIG. 25A is a perspective view depicting a CVTN bracket assembly, in accordance with an embodiment of the disclosure.

FIG. 25B is a perspective view depicting the bracket assembly of FIG. 25A operably coupled to a CVTN, in accordance with an embodiment of the disclosure.

FIG. 26A is a perspective view depicting a CVTN bracket assembly, in accordance with an embodiment of the disclosure.

FIG. 26B is a perspective view depicting the bracket assembly of FIG. 26A operably coupled to a CVTN, in accordance with an embodiment of the disclosure.

FIG. 27A is a perspective view depicting a CVTN bracket assembly, in accordance with an embodiment of the disclosure.

FIG. 27B is a perspective view depicting the bracket assembly of FIG. 27A operably coupled to a CVTN, in accordance with an embodiment of the disclosure.

FIG. 28A is a perspective view depicting a CVTN bracket assembly, in accordance with an embodiment of the disclosure.

FIG. 28B is a perspective view depicting the bracket assembly of FIG. 28A operably coupled to a CVTN, in accordance with an embodiment of the disclosure.

FIG. 29A is a perspective view depicting a CVTN bracket assembly, in accordance with an embodiment of the disclosure.

FIG. 29B is a perspective view depicting the bracket assembly of FIG. 29A operably coupled to a CVTN, in accordance with an embodiment of the disclosure.

FIG. 30A is a perspective view depicting a CVTN bracket assembly, in accordance with an embodiment of the disclosure.

FIG. 30B is a perspective view depicting the bracket assembly of FIG. 30A operably coupled to a CVTN, in accordance with an embodiment of the disclosure.

FIGS. 31A-D are perspective views depicting a bracket assembly operably coupling a CVTN to an internal surface of a battery tray, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

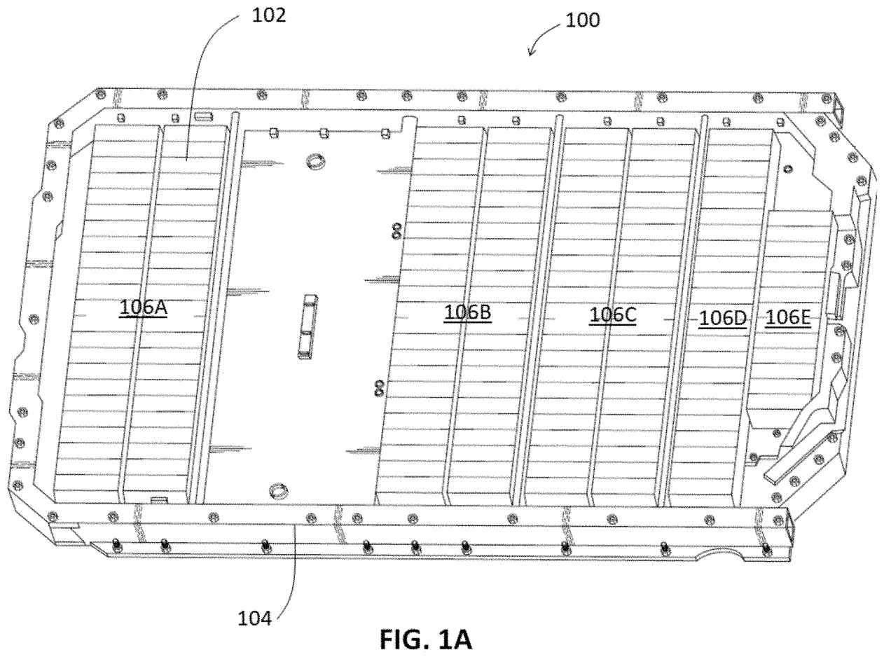

Referring to FIG. 1A, an efficient, energy dense, battery pack 100 comprised of a plurality of individual battery cells 102 positioned within a battery tray 104 is depicted in accordance with an embodiment of the disclosure. As depicted, the individual cells 102 are grouped into five distinct clusters 106A, 106B, 106C, 106D, and 106E, wherein each of clusters 106A, 106B and 106C comprise two rows of cells 102; although the grouping of the individual cells 102 into other quantities of clusters of varying shapes and sizes is also contemplated. In addition to the clusters 106, the battery pack can additionally include one or more electrical current transmission systems, temperature control systems, safety systems, battery management systems (BMS), and structural support systems (in addition to the structural support provided by the battery tray 104 itself).

With additional reference to FIG. 1B, a cover 108 can be fixed to the battery tray 104, thereby creating a sealed battery cell compartment containing be clusters 106 of individual cells 102. Thereafter, the assembled the battery pack 100 can be mounted to the frame and/or chassis of a vehicle 110, which in some embodiments can be positioned adjacent to a cabin floor 112 of the vehicle 110, thereby maintaining a low center of gravity.

Various embodiments of the present invention will be described in detail with reference to the drawings, wherein like reference numerals represent like parts and assemblies throughout the several views. Various directions and orientations, such as “upward,” “downward,” “top,” “bottom,” “upper,” “lower”, etc. are generally described herein with reference to the drawings in the usual gravitational frame of reference, regardless of how the components may be oriented during assembly.

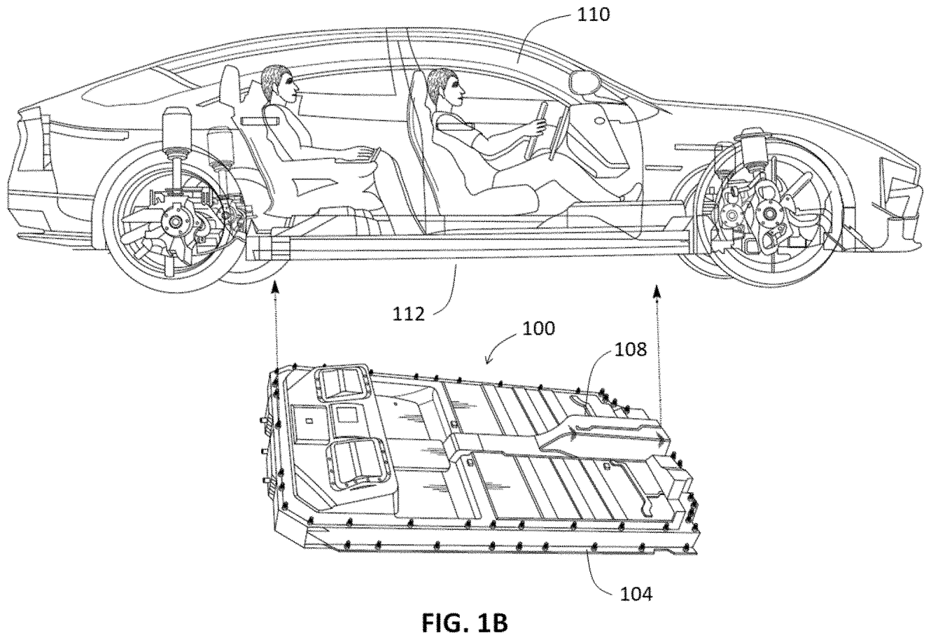

Referring to FIG. 2A, in some embodiments, each cluster 106 of cells 102 can be banded together. For example, in some embodiments, one or more bands of material 114A, 114B can be wrapped around the group of cells 102, thereby firmly affixing a large quantity of cells 102 together without significantly adding to the weight or bulk of the cluster 106. In some embodiments, the band of material 114 can be constructed of a variety of suitable materials (e.g., metal, plastic, or the like) configured to withstand the forces typically experienced by an electric vehicle battery pack during normal operation. As further depicted, in FIGS. 2A-B, in some embodiments, at least one of the one or more bands 114 can be operably coupled to an L-bracket 116, which can in turn be operably coupled to the battery tray 104 (e.g., a crossmember 118 located within the battery tray 104). For example, in some embodiments, the L-bracket 116 can be operably coupled to the crossmember 118 via one or more fasteners, an adhesive material, or the like. Operably coupling the banded cluster 106 to other portions of the battery tray 104 is also contemplated.

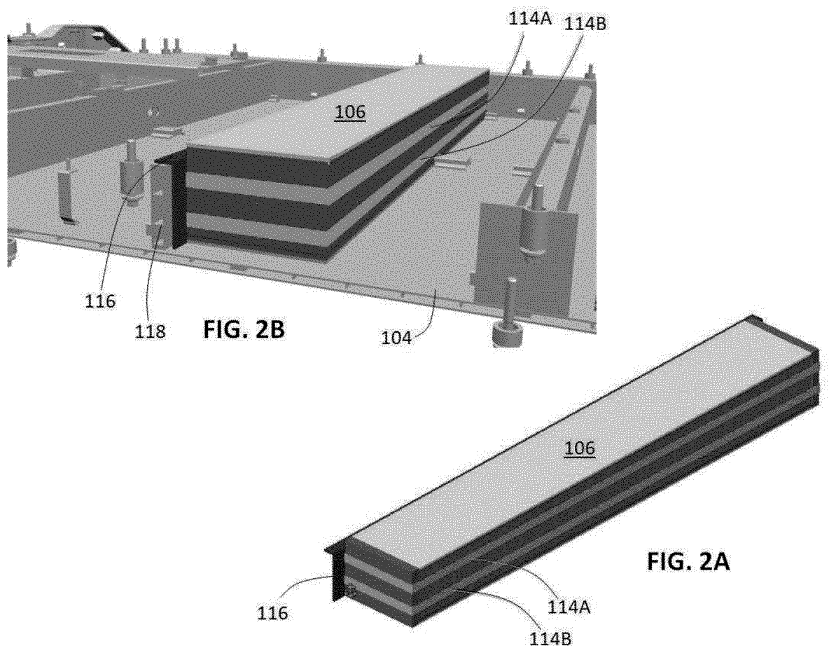

As depicted in FIGS. 3A-B, in another embodiment, one or more bands material 114 can be operably coupled to a bracket 120, configured to mate with a fixation member 122 positioned within the battery tray 114. For example, in some embodiments, the bracket 120 can be positioned along an end 126 (as opposed to a lateral edge) of the cluster 106. As further depicted in FIG. 3B, in some embodiments, the cluster of cells 102 can include an end plate 124 configured to absorb stress exerted upon the cluster 106. Accordingly, and assembled cluster 106 of battery cells 102, banded together with a band 114 of material, can be easily loaded into the battery tray 104 and secured in position.

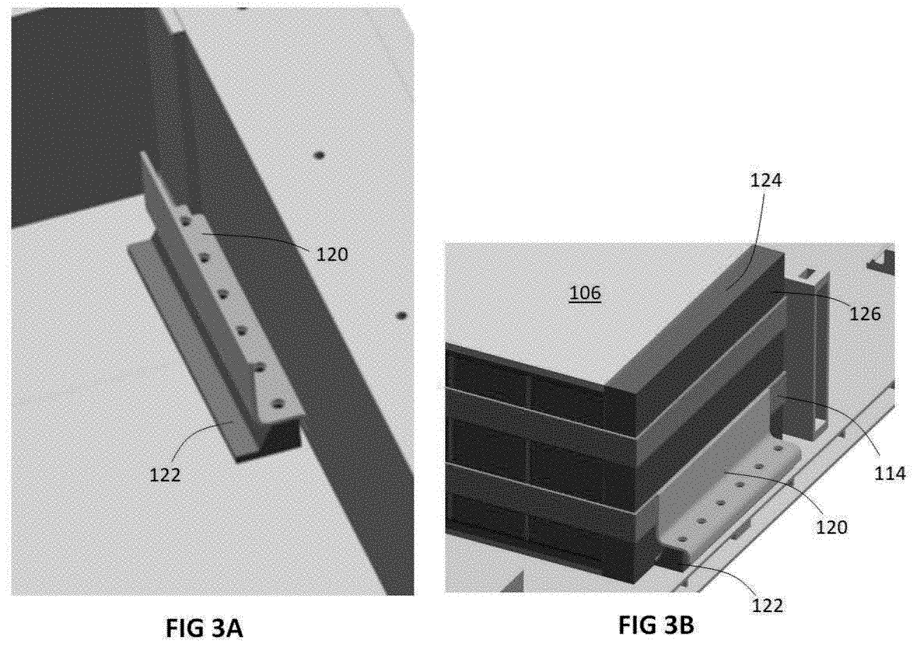

As depicted in FIGS. 4A-C, in another embodiment, a plurality of brackets 128A/B can be positioned along the one or more bands material 114. As depicted in FIG. 4C, the plurality of brackets 128A/B can be configured to mate with a corresponding plurality of fixation members 130A/B mounted within the battery tray 104, thereby securing be cluster 106 in a fixed position relative to the battery tray 104.

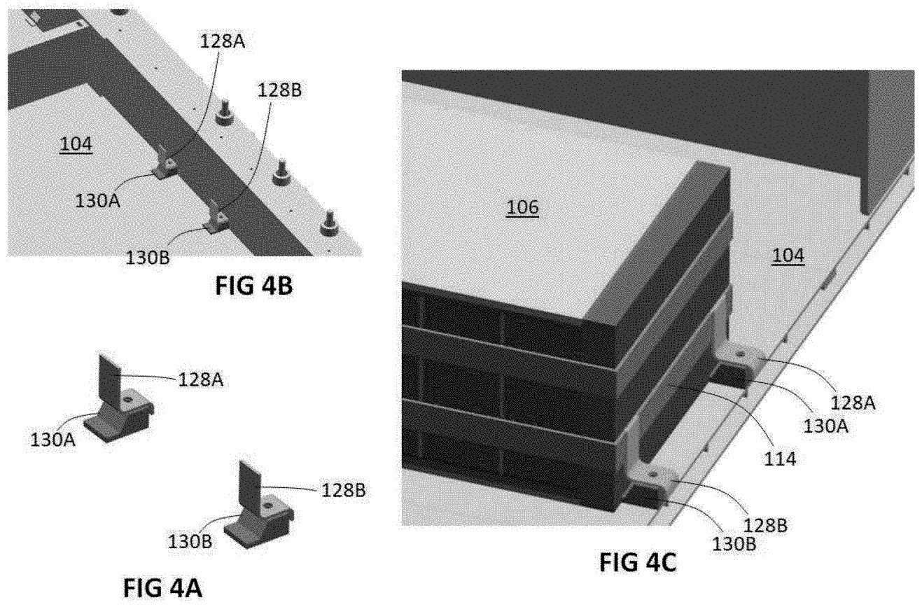

As depicted in FIGS. 5A-C, in another embodiment, one of the one or more bands 114 can be configured to be secured to a bracket 132 operably coupled to the battery tray 104. For example, in some embodiments, the bracket 132 can be configured to mount to a vertical surface within the battery tray 104. In some embodiments, the bracket 132 can be configured to couple directly to the band 114. In other embodiments, the cluster 106 can be operably coupled to the bracket 132 via one or more fixation members (not picked) operably coupled to the band 114. In some embodiments, the bracket 132 can define a tray or channel 134 configured to receive at least a portion of the band 114 or fixation member. Thereafter, one or more fasteners, adhesive or the like can be used to fixedly coupled be cluster 106 in place relative to the bracket 132.

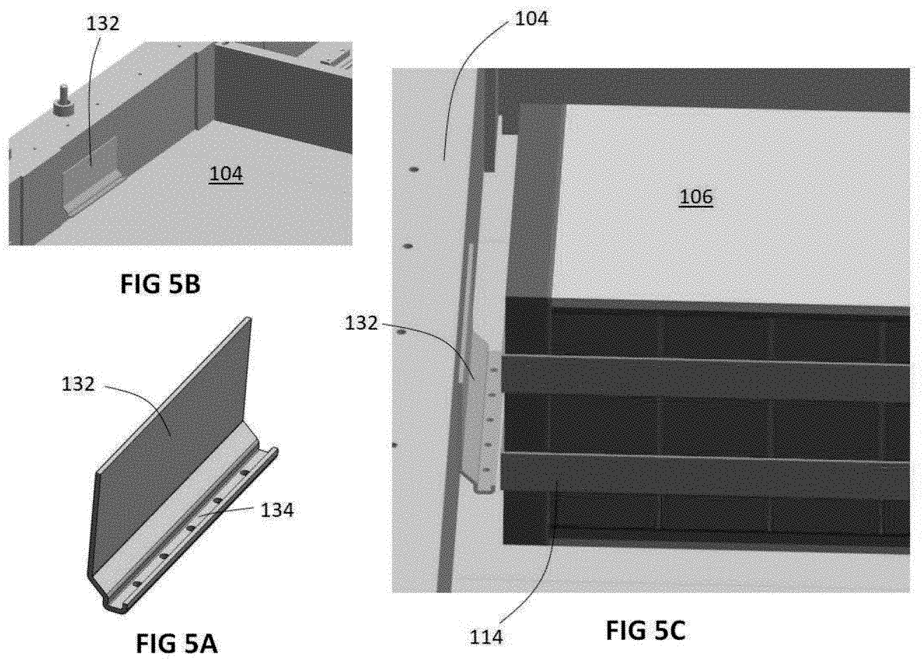

With additional reference to FIGS. 6A-B, in another embodiment, the bracket 132 defining a channel 134 into which a portion of the one or more band 114 can be positioned, can further define a resilient retention member 136 configured to be deflected inwardly towards a body of the bracket 132 as the band 114 is positioned into the channel 134, and naturally spring back into and on deflected position, thereby inhibiting removal of the band 114 from the channel 134. Accordingly, in some embodiments, the cluster 106 can be secured in position relative to the battery tray 104 without a further need to insert fasteners, apply adhesive, or the like, thereby decreasing the labor and materials in construction of the battery 100.

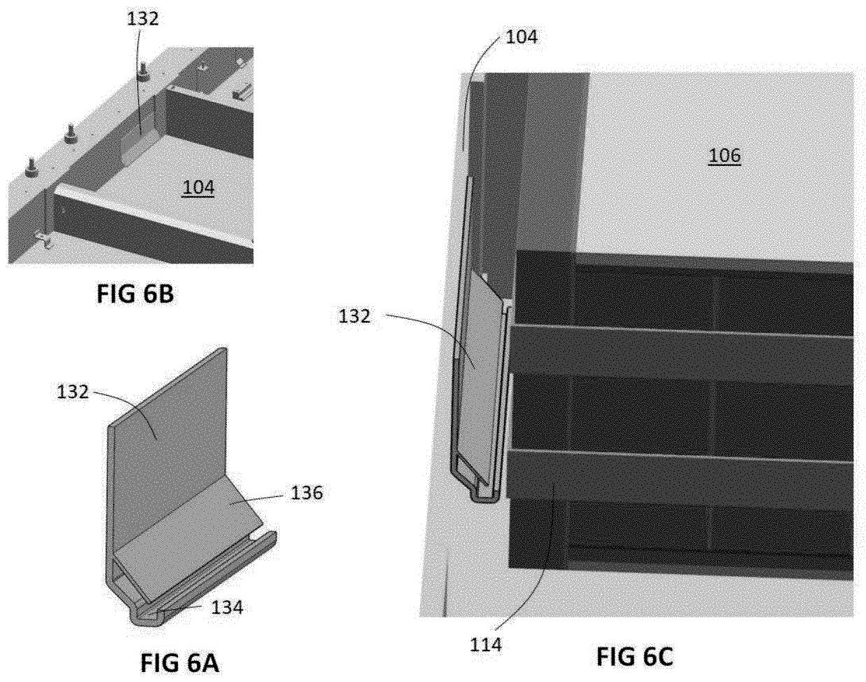

As depicted in FIG. 7, in another embodiment, an E-bracket 138 can be joined or otherwise operably coupled to the end plate 124 of the cluster 106, with one or more fasteners 140A/B operably coupling the E-bracket 138 to a retention member 142 positioned within the battery tray 104. In some embodiments, the retention member 142 can be integrally formed within the battery tray 104, for example in the form of a crossmember or other vertical surface within the battery compartment.

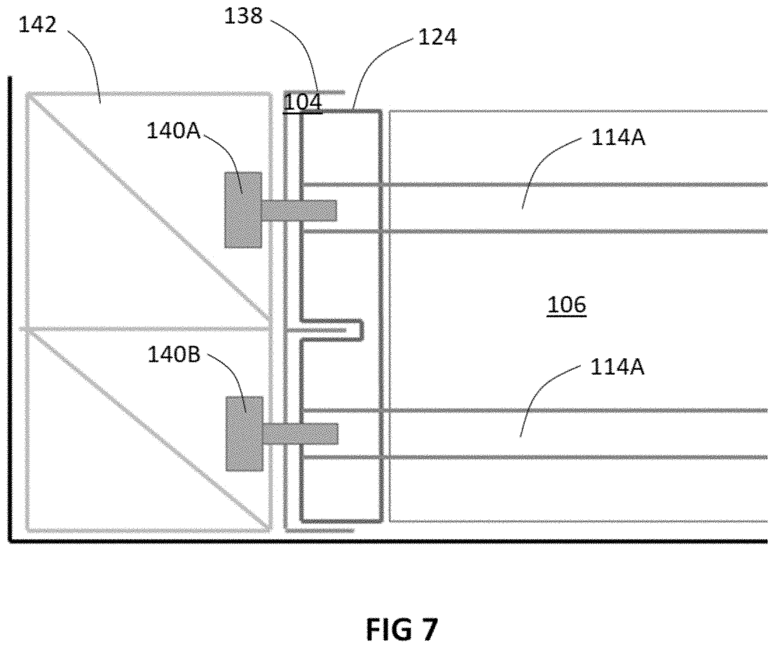

As depicted in FIGS. 8A-C, in another embodiment, a stud or other protrusion (not depicted) can extend outwardly from the one or more bands 114 surrounding the cluster 106. When positioned in the battery tray 104, the stud or protrusion can be received within one or more slots 144 defined within a retention bracket 146 mounted within the battery tray 114. In order to further secure the stud or protrusion within the one or more slots 144, in some embodiments, one end of a retention plate (not depicted) can be positioned within an aperture 152 defined in a top surface of the retention bracket 146, with an opposite end of the retention plate secured in place with a fastener inserted into aperture 150.

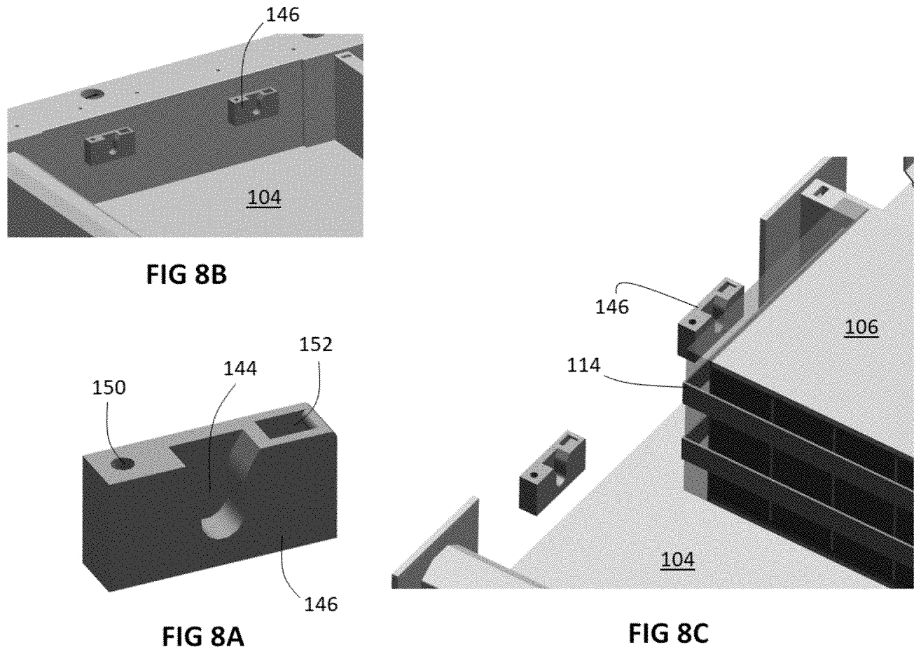

Other methods of securing the stud or protrusion in place within the slot 144 are also contemplated. For example, as depicted in FIGS. 9A-C, in another embodiment, the retention bracket 146 can include one or more resilient bayonet couplings 154A/B configured to flex or temporarily deflect outwardly away from the one or more slots 114A/B as the studs or protrusions extending outwardly from the one or more bands 114 are positioned in the one or more slots 114. Thereafter, the one or more resilient bayonet couplings 154A/B can spring back into an un-deflected position, thereby inhibiting removal of the studs or protrusions from the one or more slots 114.

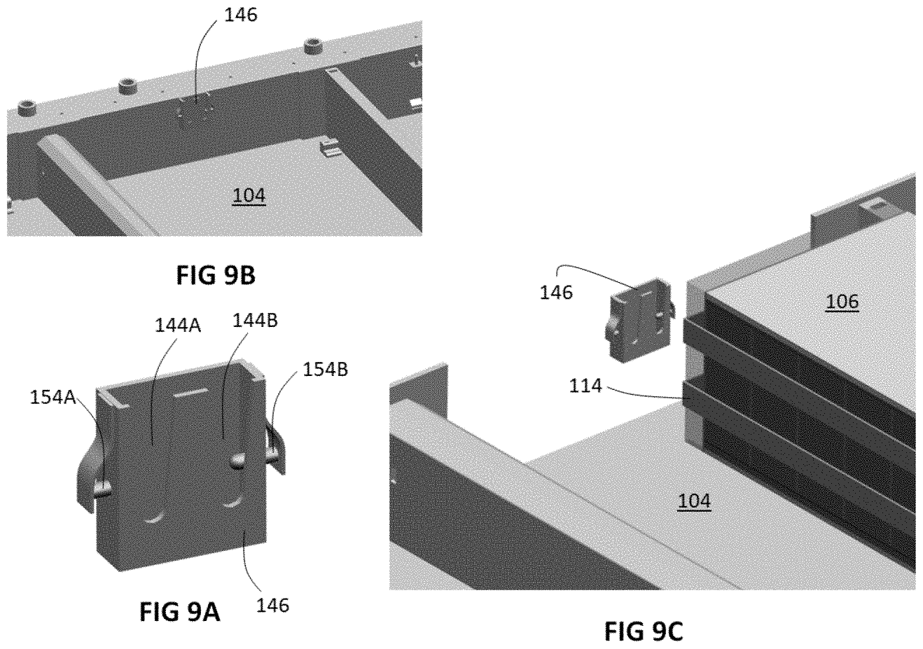

As depicted in FIGS. 10A-B, in another embodiment, the stud or protrusion extending outwardly from the band 114 can be configured as a T-stud, configured to sliding reengage with a T-shaped channel 156 formed within a vertical surface of the battery tray 104. In some embodiments, a bracket 158A/B defining the T-shaped channel 156 can be fixedly coupled to the battery tray 104. In other embodiments, the T-shaped channel 156 can be integrally formed within the battery tray 104, thereby reducing number of required components in the construction of the battery 100.

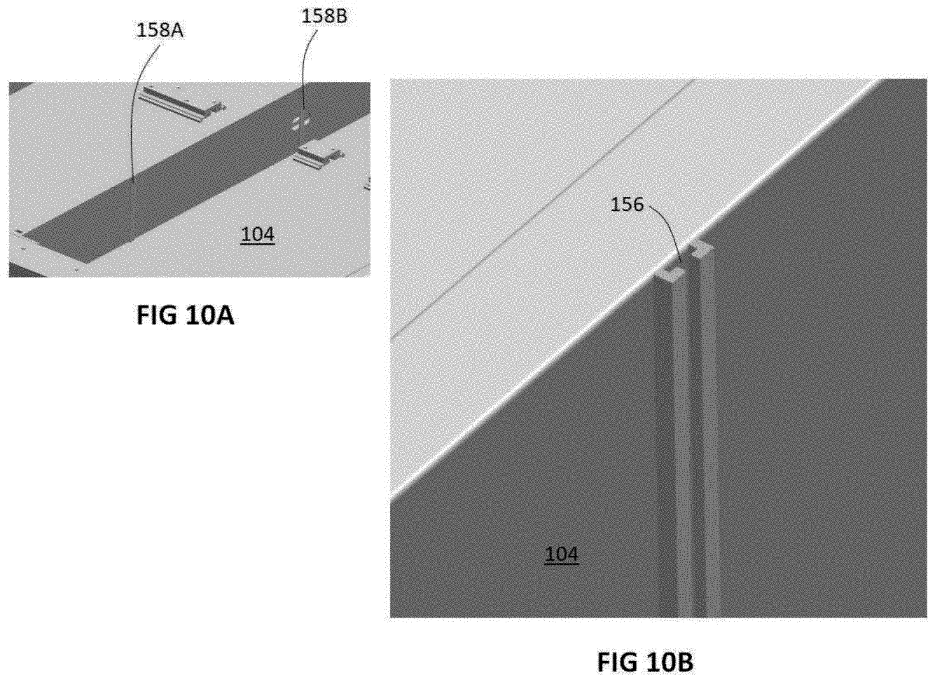

As depicted in FIGS. 11A-C, in another embodiment, the T-stud extending outwardly from the band 114 can be configured to selectively locked into a key slot 160 formed within either a vertical or horizontal surface within the battery tray 104. In some embodiments, a bracket 162 defining the key slot 160 can be fixedly coupled to the battery tray. In other embodiments, the key slot 160 can be integrally formed within the battery tray, thereby reducing the number of required components in the construction of the battery.

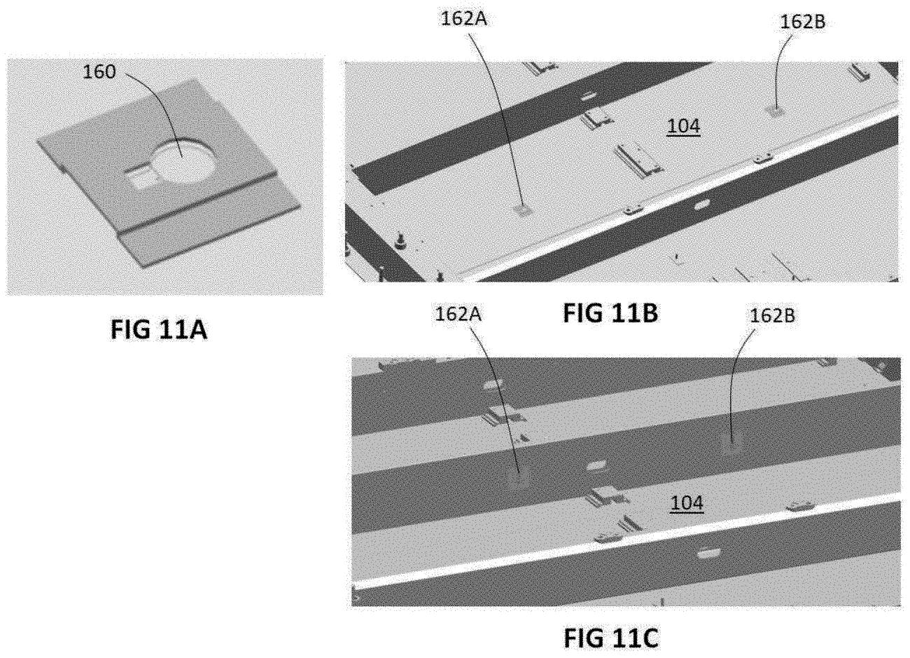

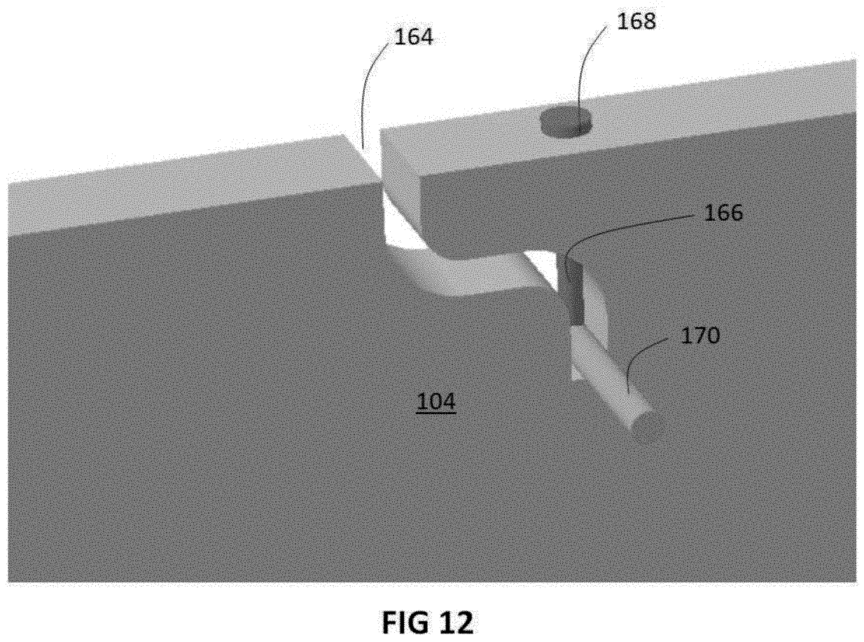

As depicted in FIG. 12, in another embodiment, a stud or protrusion 170 extending outwardly from the band 114 can be slidably engaged with an S-shaped or other curvilinear shaped slot or channel 164 defined within the battery tray 104. Thereafter, a pin or other fastener 166 can be inserted through an aperture 168, thereby locking the stud or protrusion in place within the channel 164. In some embodiments, the pin or other fastener 166 can serve a dual function of additionally securing the cover 108 of the battery 100 to the battery tray 104. As depicted in FIGS. 13A-B, in another embodiment, one or more retention clips 172 can be configured to secure the clusters 106 and positioned within the battery tray 104. In some embodiments, the one or more retention clips 172A/B can include an angled resilient portion 174 configured to temporarily deflect as the cluster 106 exerts a force there on. Once the cluster 106 is in positioned within the battery tray 104, the angled resilient portion 174 can spring back to an un-deflected position, thereby inhibiting removal of the cluster 106 from the battery tray 104.

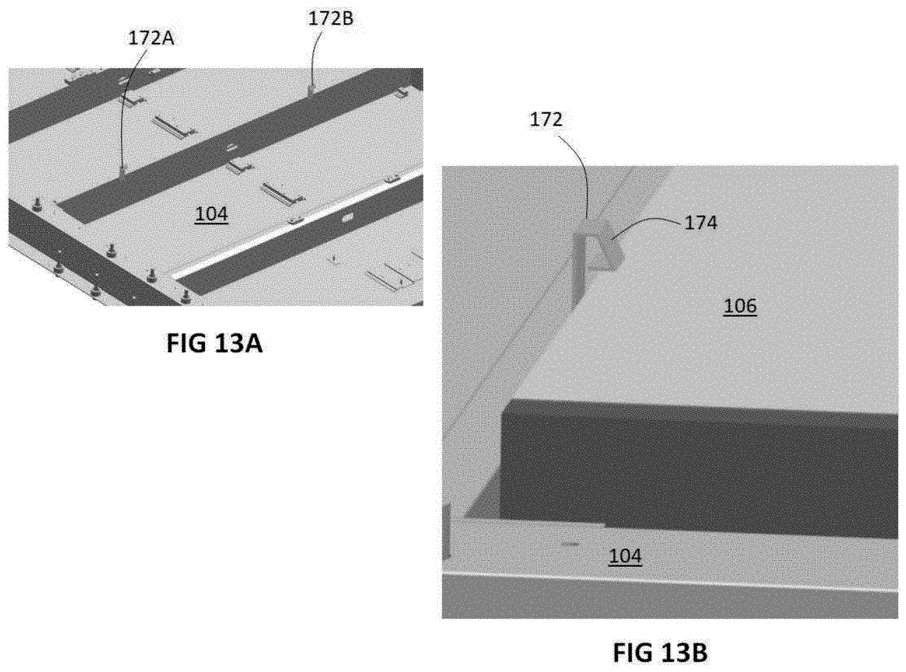

As depicted in FIGS. 14A-B, in another embodiment, a banded or un-banded cluster 106 of individual cells can positioned within a retention bracket 176. For example, in one embodiment, the retention bracket can include one or more lateral cross bands 178A-C configured to wrap around a lateral portion of the cluster 106. In some embodiments, the lateral cross bands 178A-C can include a vertical support 180 configured to be positioned between rows of individual cells. One or more longitudinal supports 182A-B can be positioned substantially orthogonal to the one or more lateral cross bands 178A-C, and extend generally across a top portion of the cluster 106, thereby securing the cluster 106 to the battery tray 104.

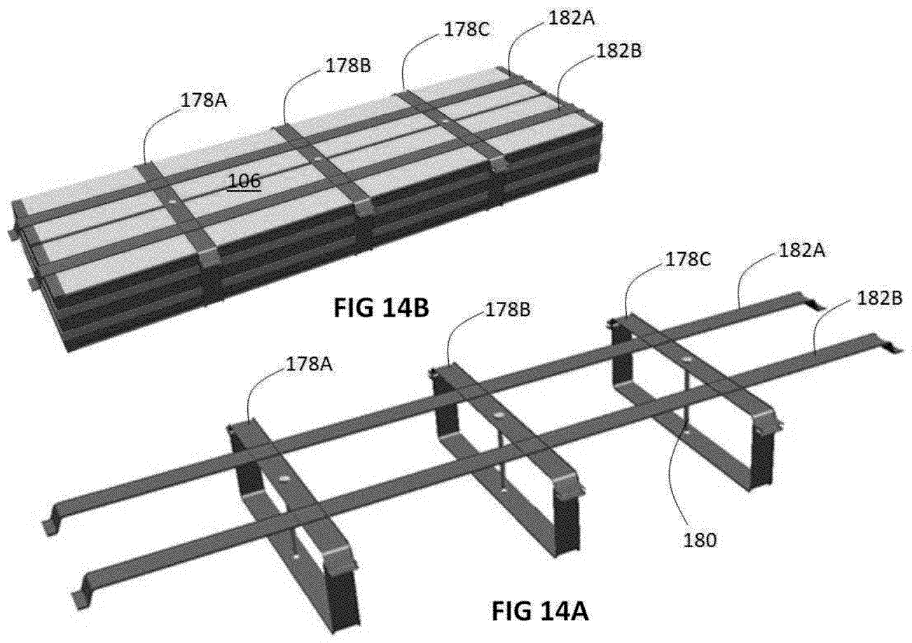

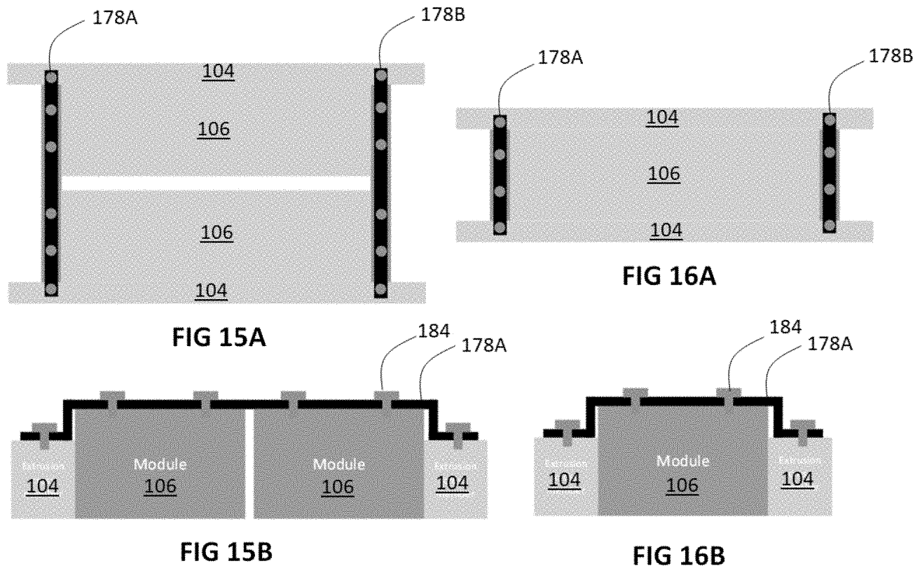

As depicted in FIGS. 15A-B & 16A-B, in some embodiments, at least one of the one or more lateral cross bands 178A-B can be operably coupled to the cluster 106 and/or battery tray 104 via one or more fasteners 184. In some embodiments, the one or more lateral cross bands 178A-B are configured to traverse across a top surface of the cluster 106 only, so as to not encircle and/or pass underneath the cluster 106. Other configurations of the retention bracket 176 are also contemplated.

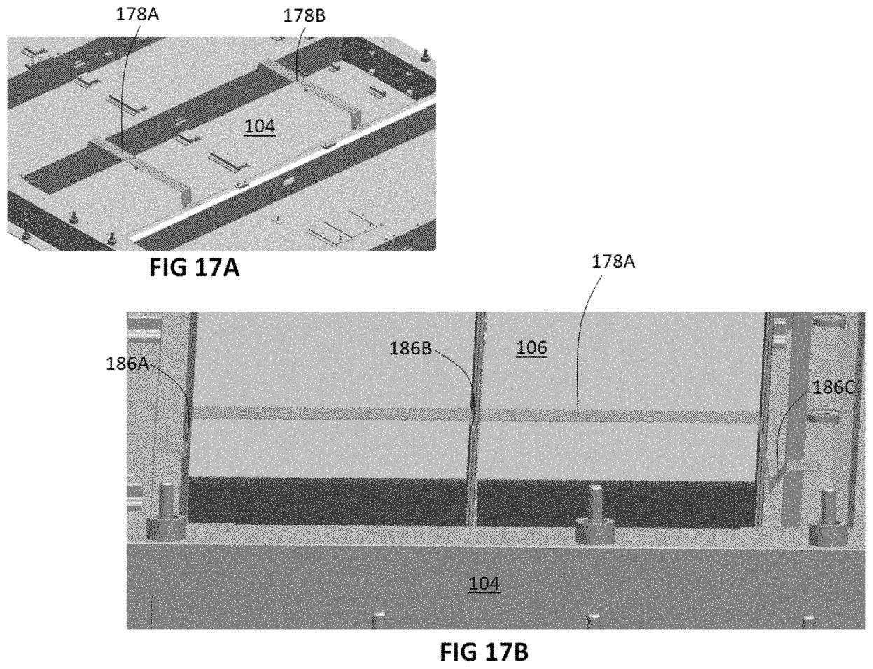

For example, as depicted in FIGS. 17A-B, in one embodiment, the one or more lateral cross bands 178A/B can define one or more guide members 186A-C configured to be positioned adjacent to the lateral sides of the individual battery cells, as well as between individual rows of battery cells. In some embodiments, the one or more guide members 186A-C can be configured as V-shaped bends within the one or more lateral cross bands 178A/B. The V-shaped bend configuration of the one or more guide members 186A-C configured to at least partially absorb physical shock and/or external forces experienced by the cluster 106, and to encourage realignment of the rows of individual cells within the cluster 106, should they become unaligned.

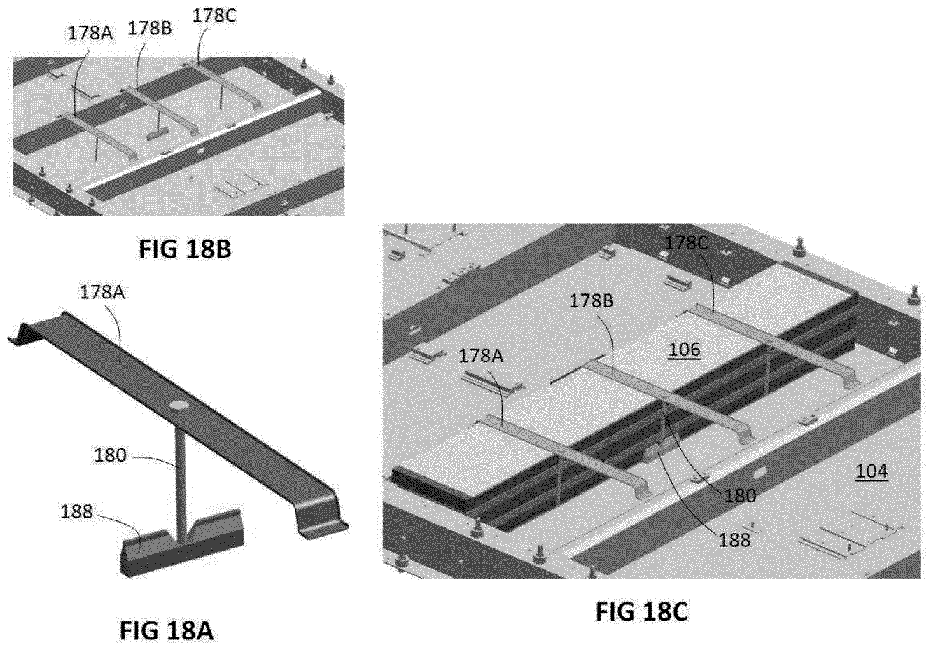

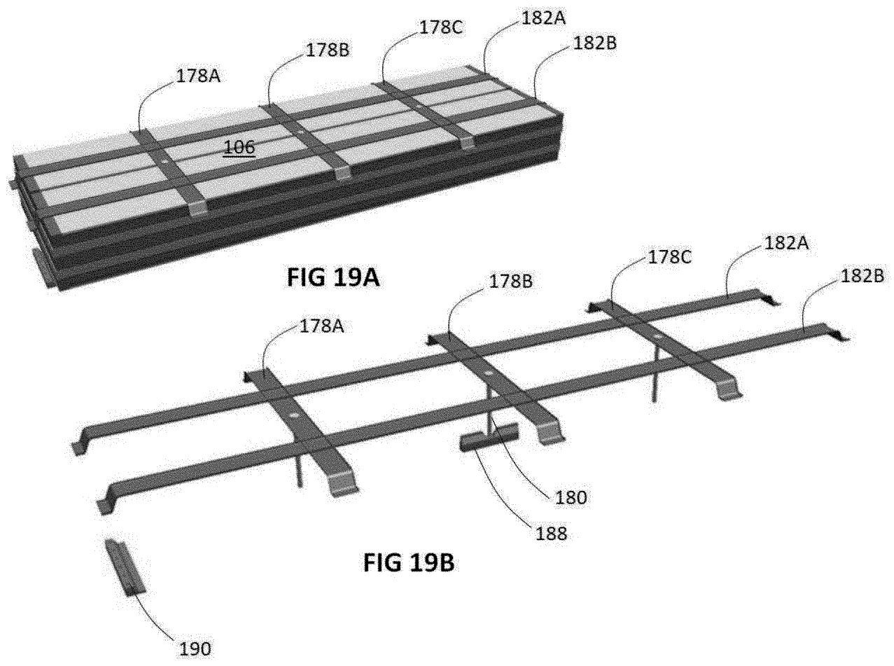

With additional reference to FIGS. 18A-C & 19A-B, in some embodiments, the one or more lateral cross bands 178A-C can include a vertical support 180 configured to be positioned between rows of individual cells, with a wedge portion 188 operably coupled to a bottom of the vertical support 180, such that as the vertical support 180 is tightened (e.g., via a threaded coupling) the wedge portion 188 can be forcibly positioned between rows of cells, thereby ensuring a proper spacing between respective rows and locking the rows of cells into position relative to one another as well as relative to the battery tray 104. As further depicted in FIG. 19B, in some embodiments, a bottom portion of the cluster 106 can be configured to interface with a fixation element 190 operably coupled to a bottom portion of the battery tray 104, thereby securing the cluster 106 in position relative to the battery tray 104.

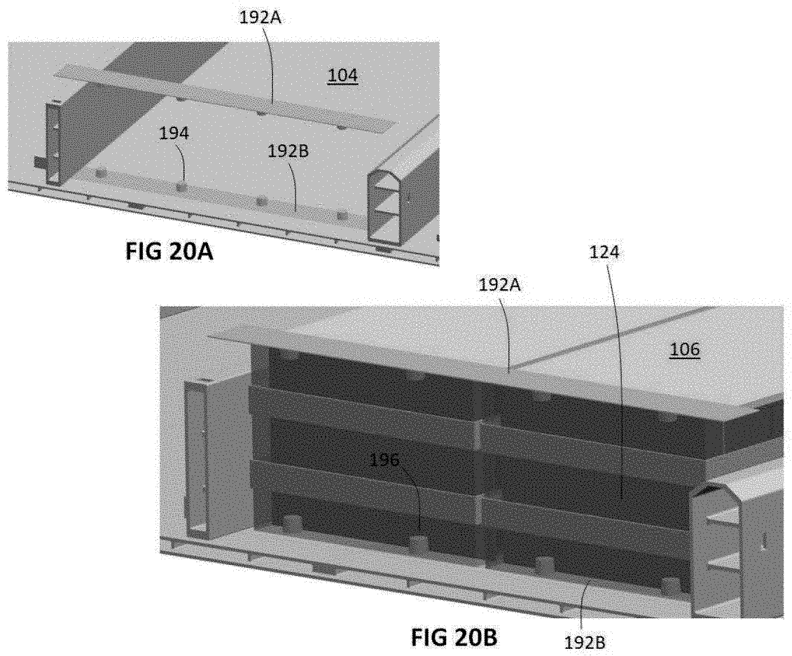

With reference to FIGS. 20A-B, in another embodiment, one or more lateral cross members 192A/B can be positioned adjacent to respective top and bottom surfaces of the battery tray 104, and can be configured to engage with the end plate 124 of the cluster 106, thereby securing the cluster 106 of battery cells to the battery tray 104. For example, in some embodiments, the one or more lateral cross numbers 192A/B can define a plurality of cones 194 or other protrusions, which can be configured to be received within correspondingly shaped apertures 196 defined by the end plate 124. In some embodiments, the one or more lateral cross members 192A/B can be integrally formed into the cover 108 and bottom surface of the battery tray 104, thereby reducing the overall number of components necessary for the construction of the battery pack 100.

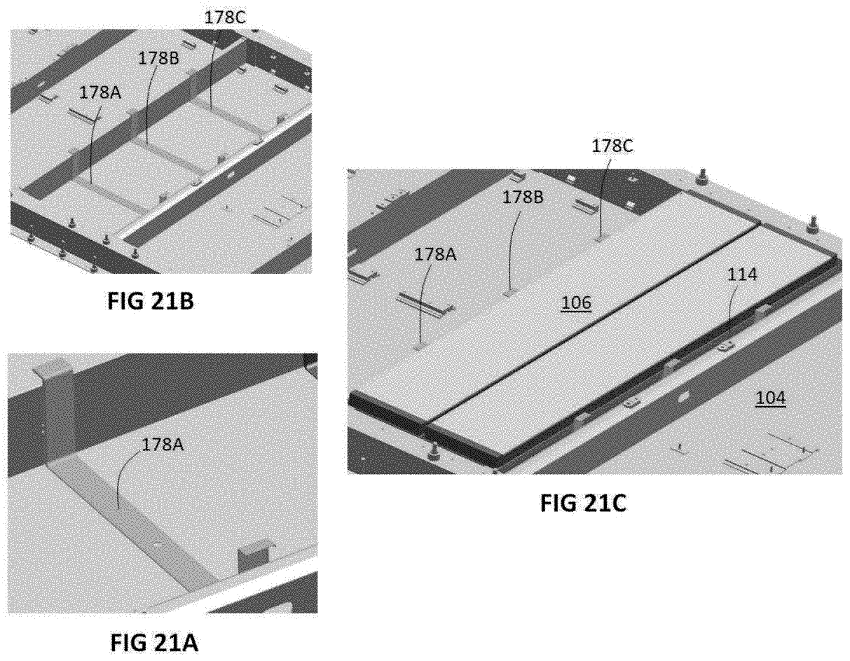

With reference to FIGS. 21A-C, in another embodiment, at least one of the one or more lateral cross members 178A-C can be configured to support a bottom and side surfaces of the cluster 106, thereby adhering the cluster 106 to the battery tray 104. For example, in some embodiments, the one or more lateral cross members 178A-C can be fixed in position relative to the cluster 106 via the bands 114. Thereafter, the one or more lateral cross members 178A-C can be operably coupled to the battery tray, for example via one or more fasteners, adhesive, or the like. Other systems and methods of operably coupling the cluster 106 to the battery tray 104 are also contemplated.

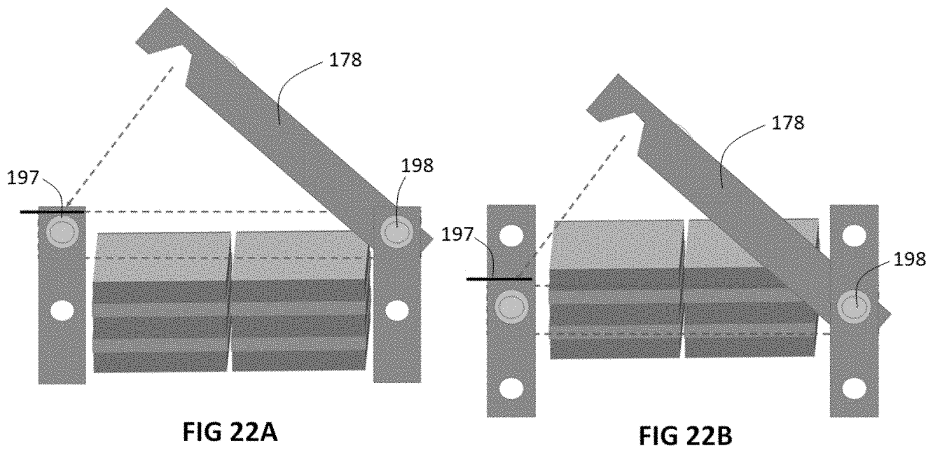

For example, with reference to FIGS. 22A-B, in yet another embodiment, the one or more lateral cross members 178 can be pivotably coupled to the battery tray 104, for example via a hinge 198. With the cluster 106 of individual cells positioned within a compartment of the battery tray 104, the lateral cross member 178 can be pivoted into contact or otherwise securing position, thereby securing the cluster 106 within the battery tray. In some embodiments, the one or more lateral cross members 178 can be selectively locked in position with the insertion of a pin 197. As depicted in FIG. 22A, in some embodiments, the lateral cross member 178 can traverse across a top portion of the cluster 106. In other embodiments, such as that depicted in FIG. 22B, the lateral cross member 178 can be configured to matingly engage with an end plate of the cluster 106. Other configurations are also contemplated.

In addition to the grouping of individual battery cells 102 into distinct clusters 106 for mounted into the battery tray 104, the battery pack 100 typically also includes at least one cell voltage temperature node (CVTN). In some embodiments, the battery pack 100 can include one CVTN for each cluster 106 of battery cells. For example, in one embodiment, the battery pack 100 can include a total of eight CVTNs; although the use of other quantities of CVTNs is also contemplated. As the CVTNs were typically incorporated into the battery modules in the past, the CVTNs must now be independently positioned within the battery tray 104, like the clusters 106 of individual battery cells. Various systems and methods are contemplated for securing the CVTNs within the battery tray 104.

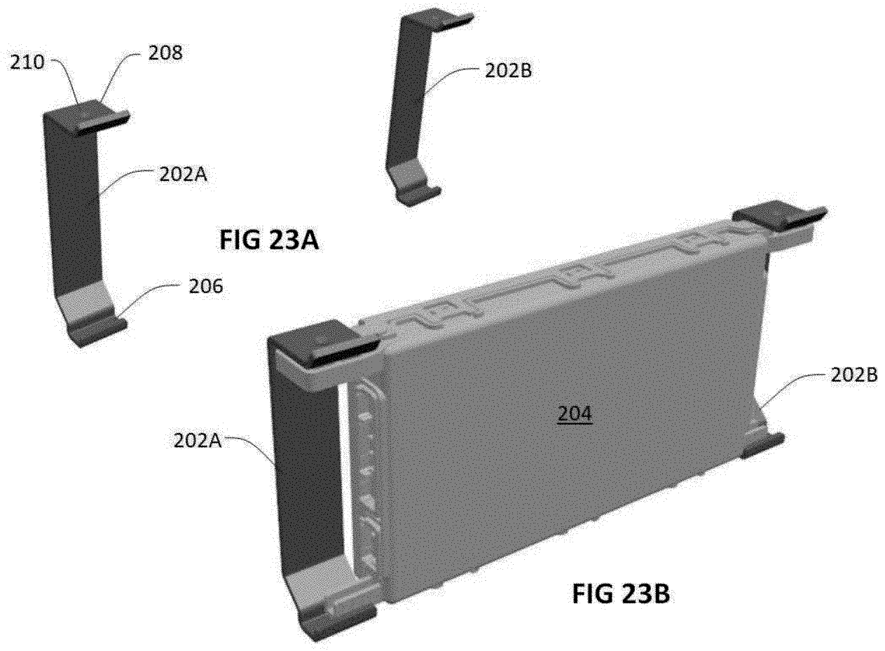

For example, with reference to FIGS. 23A-B, in one embodiment, a pair of brackets 202A/B can be used to operably couple the CVTN 204 to a surface within the battery tray 104. In some embodiments, each of the brackets 202 can include a trough or channel 206 located on a lower portion of the bracket 202, shaped and sized to enable a portion of the CVTN 204 to be positioned therein. Further, each of the brackets 202 can include a restriction plate 208 located on an upper portion of the bracket 202 configured to inhibit movement of the CVTN 204 beyond the restriction plate 208. During installation, a portion of the CVTN 204 can be inserted into the channels 206 of the brackets 202, then pivoted or rotated such that a second portion of the CVTN 204 contacts or comes into close proximity to the restriction plates 208 of the brackets 202. To further secure the CVTN 204 in position relative to the brackets 202, a fastener can be passed through an aperture 210 defined in the restriction plates 208. Other configurations of the brackets 202 are also contemplated.

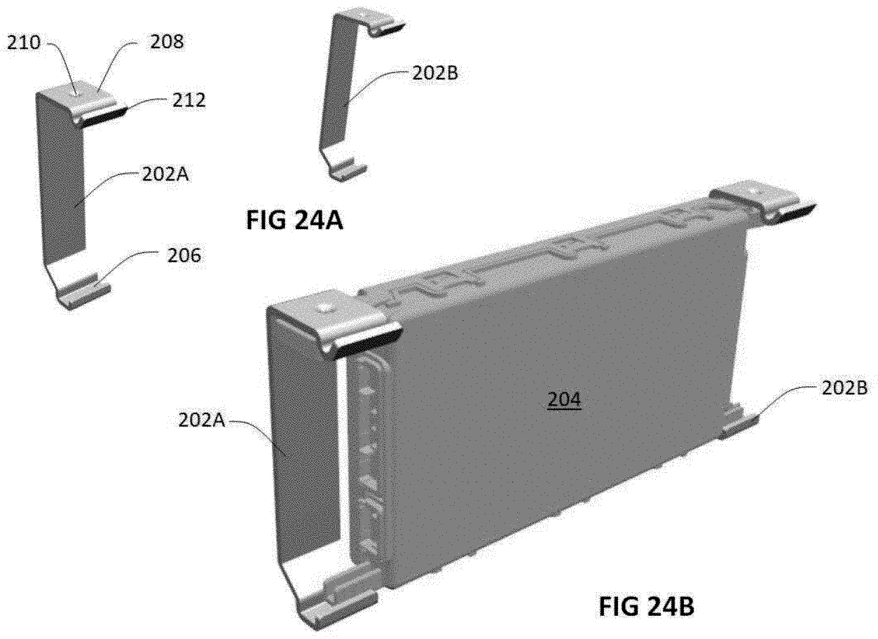

For example, with reference to FIGS. 24A-B, in one embodiment, the pair of brackets 202A/B can include a resilient retention member 212 configured to flex or temporally deform so as to enable the CVTN 204 to be pivoted or rotated that a second portion of the CVTN 204 contacts or comes into close proximity to the restriction plates 208 of the brackets 202. Thereafter, the resilient retention members 212 can spring back into an un-deflected position, thereby inhibiting removal of the CVTN 204 from the brackets 202A/B. Accordingly, in some embodiments, the CVTN 204 can be operably coupled to the battery tray 104 without the use of additional fasteners, adhesive, or the like, thereby reducing the amount of labor and materials required in the assembly of a battery pack 100.

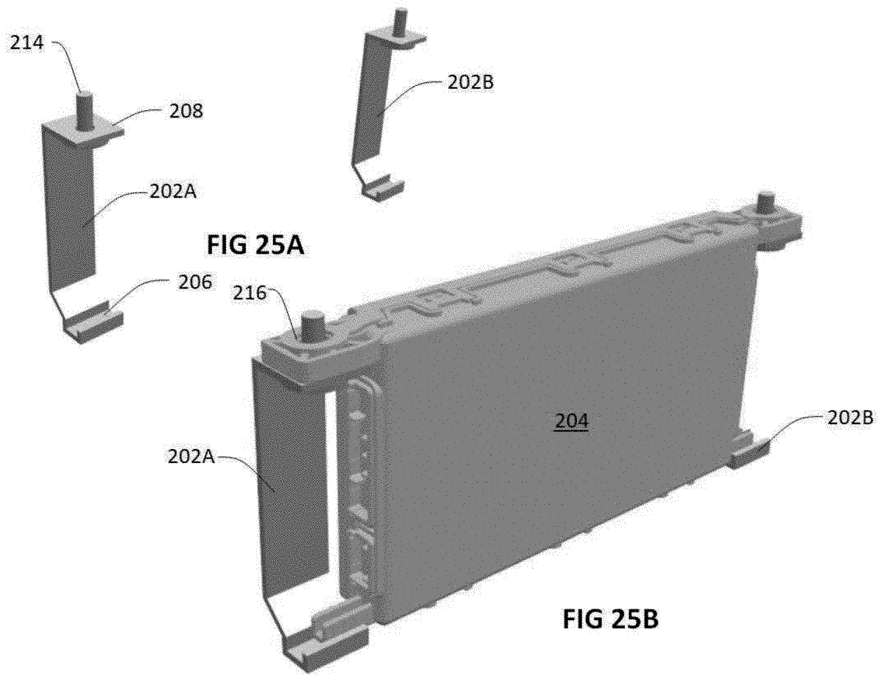

With reference to FIGS. 25A-B, in one embodiment, the channels 206 and the restriction plates 208 can serve as contacting surfaces for portions of the CVTN 204, thereby securely fastening the CVTN 204 to the pair of brackets 202A/B. For example, in one embodiment, each restriction plate 208 can include a post 214 configured to traverse through a corresponding aperture 216 defined in the CVTN 204, thereby inhibiting movement of the CVTN 204 relative to the restriction plate 208. During installation, a portion of the CVTN 204 can be aligned with the channels 206 of the brackets 202, then rotated slightly into an upright position for alignment of the aperture 216 of the CVTN 204 with the posts 214 of the pair of brackets 202A/B. The CVTN 204 can then be shifted into contact with the channels 206 and the restriction plates 208, thereby securing the CVTN 204 relative to the pair of brackets 202A/B. In some embodiments, the posts 214 can be threaded, such that a nut or other threaded coupling member can be applied to the post after installation of the CVTN 204, thereby further securing the CVTN 204 relative to the pair of brackets 202A/B.

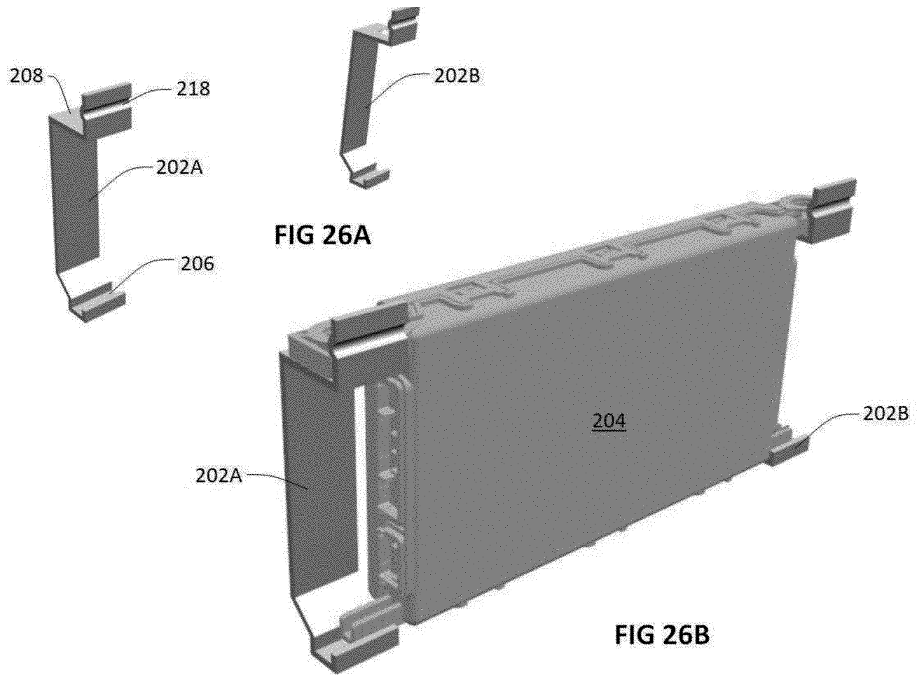

With reference to FIGS. 26A-B, in one embodiment, the pair of brackets 202A/B can include a resilient retention member 218 configured to flex or temporally deform, so as to enable the CVTN 204 to be shifted into contact with the channels 206 and the restriction plates 208. Thereafter, the resilient retention members 218 can spring back into an un-deflected position, thereby inhibiting removal of the CVTN 204 from the brackets 202A/B. Accordingly, in some embodiments, the CVTN 204 can be operably coupled to the battery tray 104 without the use of additional fasteners, adhesive, or the like, thereby reducing the amount of labor and materials required in the assembly of a battery pack 100.

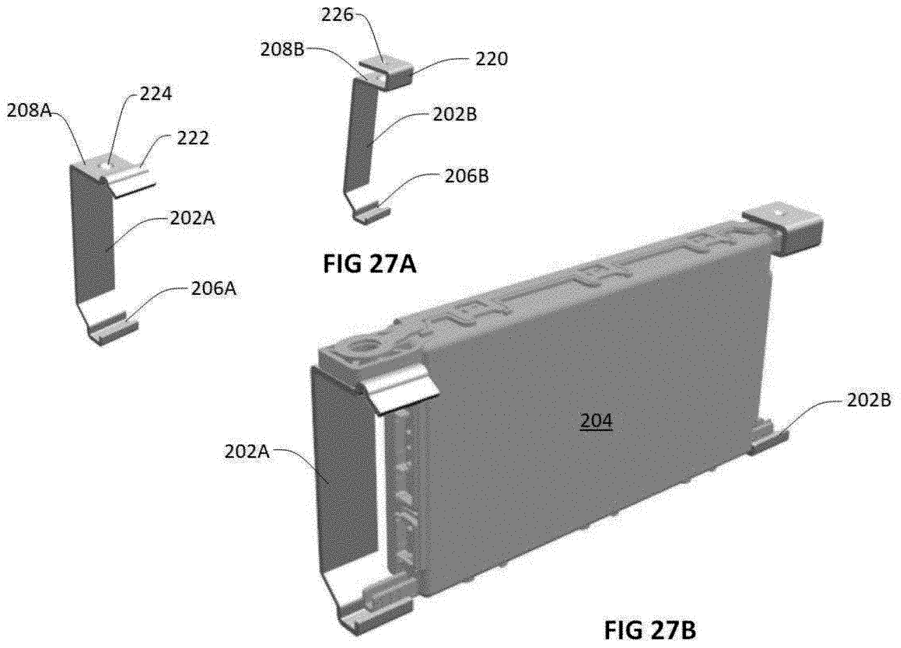

With reference to FIGS. 27A-B, in one embodiment, the pair of brackets 202A/B can be configured to enable coupling of the CVTN 204 to the pair of brackets 202A/B through a combination of, sliding, pivoting and twisting motion. For example, in one embodiment, one of the brackets 202B can define a U-shaped channel portion 220 operably coupled to the restriction plate 208B into which a portion of the CVTN 204 can be positioned. The other bracket 202A can define a resilient retention member 222 configured to flex or temporally deform, so as to enable the CVTN 204 to be shifted into contact the restriction plate 208A. During installation, a portion of the CVTN 204 can be slid into the U-shaped channel portion 220 and the channel 206B of one of the brackets 202B. Through a combination of pivoting and twisting, the CVTN 204 can then be passed over the resilient retention member 222 to comment to contact with the restriction plate 208A and the channel 206A, thereby securing the CVTN 204 relative to the pair of brackets 202A/B. In some embodiments, at least one of the restriction plates 208A/B can include a protuberance 224 configured to reside within a respective cut out of the CVTN 204, thereby aiding in retention of the CVTN 204 relative to the pair of brackets 202A/B. Further, in some embodiments, a fastener can be passed through an aperture 226 defined in the U-shaped channel portion 220, thereby locking the CVTN 204 relative to the pair of brackets 202A/B.

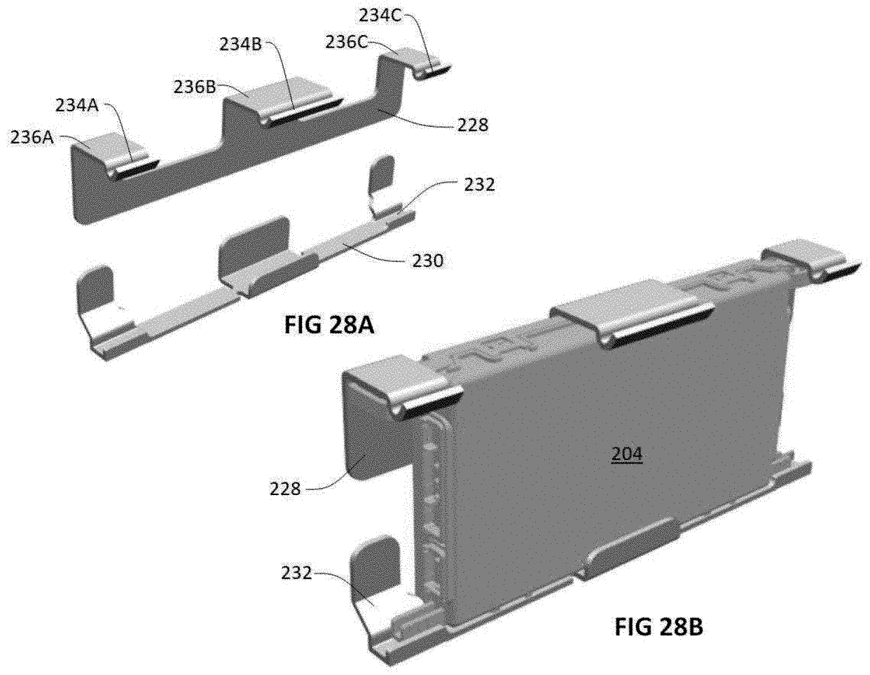

With reference to FIGS. 28A-B, in another embodiment, a pair of brackets 228, 232 can be used to operably couple the CVTN 204 to a surface within the battery tray 104. In this embodiment, a first bracket 228 can be configured to retain a top portion of the CVTN 204, while a second bracket 232 can be configured to retain a bottom portion of the CVTN 204. As an aid in retention, in one embodiment, the second bracket 232 can define one or more channels 232 into which a portion of the CVTN 204 can be positioned. The first bracket 228 can define one or more resilient retention members 234A-C configured to flex or temporally deform so as to enable the CVTN 204 to be pivoted or rotated such that a top portion of the CVTN 204 contacts or comes into close proximity with one or more restriction plates 236A-C of the bracket 228. Thereafter, the resilient retention members 234A-C can spring back into an un-deflected position, thereby inhibiting removal of the CVTN 204 from the brackets 228, 232. Accordingly, in some embodiments, the CVTN 204 can be operably coupled to the battery tray 104 without the use of additional fasteners, adhesive, or the like, thereby reducing the amount of labor and materials required in the assembly of a battery pack 100.

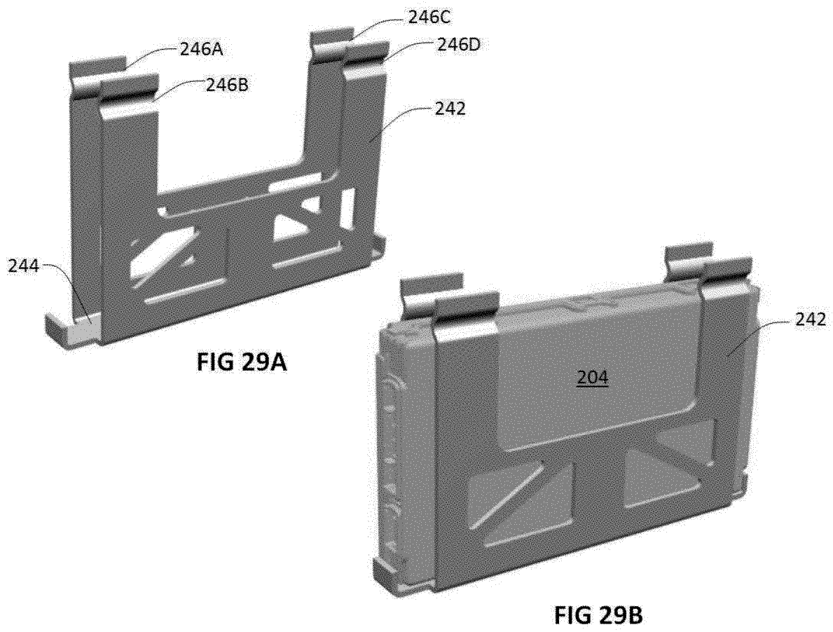

Referring to FIGS. 29A-B, in another embodiment, the bracket 242 can define a channel 244 (e.g., a U-shaped channel) into which a portion of the CVTN 204 can be positioned. Further, the bracket 242 can define one or more resilient retention members 246A-D configured to flex or temporally deform so as to enable the CVTN 204 to be slidably positioned within the channel 244. Thereafter, the resilient retention members 246A-D can spring back into an un-deflected position, thereby inhibiting removal of the CVTN 204 from the bracket 242. Accordingly, in some embodiments, the CVTN 204 can be operably coupled to the battery tray 104 without the use of additional fasteners, adhesive, or the like, thereby reducing the amount of labor and materials required in the assembly of a battery pack 100.

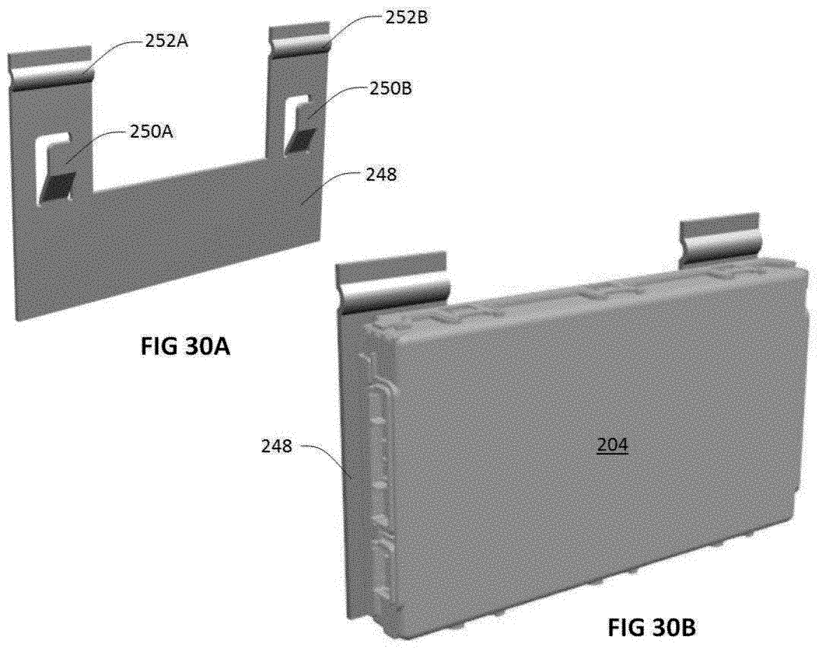

With reference to FIGS. 30A-B, in another embodiment, the bracket 248 can define one or more hooks 250A/B configured to engage with the CVTN 204 (e.g., at least partially insert into a corresponding loop defined by the CVTN 204), thereby securing the CVTN 204 in position relative to the bracket 248. As an aid in further retaining the CVTN 204 relative to the bracket 248, in some embodiments, the bracket 248 can define one or more resilient retention members 252A-B configured to flex or temporally deform so as to enable the CVTN 204 to be slidably positioned on the one or more hooks 250A/B. Thereafter, the resilient retention members 252A-B can spring back into an un-deflected position, thereby inhibiting removal of the CVTN 204 from the bracket 248.

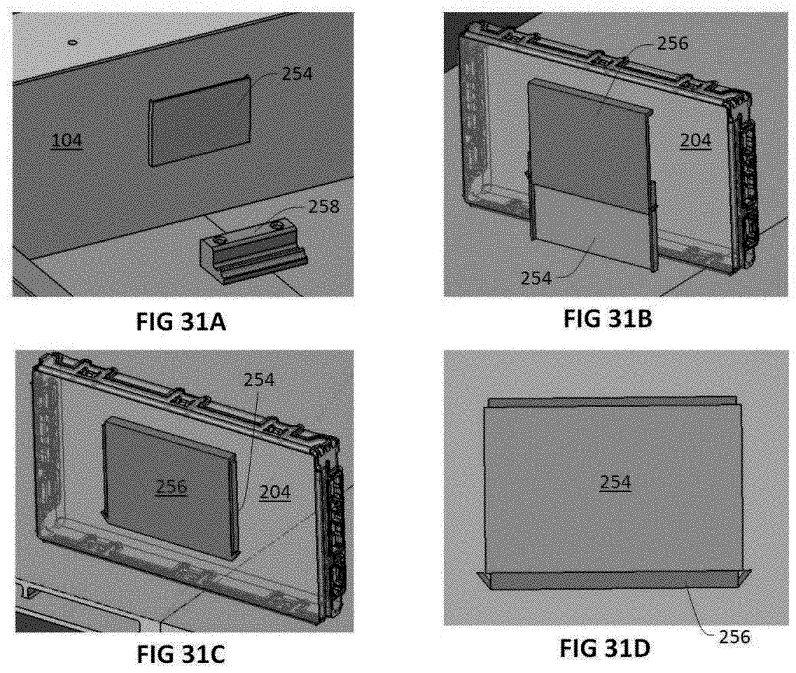

With reference to FIGS. 31A-D, in yet another embodiment, the bracket 254 can be formed as a U-shaped channel, slightly offset from a surface within the battery tray 104. A corresponding coupling member 256 of the CVTN 204 can be configured to be inserted within the U-shaped channel of the bracket 254, thereby securing the CVTN 204 in position relative to the bracket 254. As a further aid in retaining the CVTN 204 relative to the bracket 254, in some embodiments, either of the bracket 254 or the coupling member 256 can include one or more one or more resilient retention members configured to flex or temporally deform so as to enable the CVTN 204 to be slidably positioned into contact with the bracket 254. Thereafter, the resilient retention members can spring back into an un-deflected position, thereby inhibiting removal of the CVTN 204 from the bracket 254. In one embodiment, an additional fixation member 258 can be positioned within the battery tray 104 to abut up against a portion of the CVTN 204, thereby providing a further aid in securing the CVTN 204 within the battery tray 104. Other embodiments are also contemplated.

The invention is further illustrated by the following embodiments:

An electric vehicle battery pack comprising: a battery tray; and a plurality of individual battery cells; one or more bands surrounding at least a portion of the plurality of individual battery cells, thereby banding the portion of individual battery cells together in a discrete cluster; and a bracket assembly configured to operably couple the banded discrete cluster to the battery tray.

A system or method according to any embodiment, wherein the electric vehicle battery pack comprises a total of eight rows of banded individual battery cells.

A system or method according to any embodiment, wherein the discrete clusters each include an end plate configured to absorb stress exerted upon the discrete cluster.

A system or method according to any embodiment, wherein the bracket assembly is operably coupled to the battery tray by at least one of a threaded fastener, rivet, or adhesive.

A system or method according to any embodiment, wherein the bracket assembly is integrally formed within the battery tray.

A system or method according to any embodiment, wherein the bracket assembly is mounted on at least one of a horizontal or vertical surface within the battery tray.

A system or method according to any embodiment, wherein the bracket assembly includes one or more resilient portions configured to temporarily deform to enable coupling of the discrete cluster to the bracket assembly, and then to spring back to an un-deformed position to inhibit inadvertent decoupling of the bracket assembly from the discrete cluster.

A system or method according to any embodiment, wherein the one or more bands surrounding at least a portion of the plurality of individual battery cells includes a post, stud or protrusion configured to matingly engage with a portion of the bracket assembly.

A system or method according to any embodiment, wherein the bracket assembly comprises at least one lateral cross band configured to at least partially traverse around a lateral portion of the discrete cluster of banded individual cells.

A system or method according to any embodiment, wherein the bracket assembly is configured to aid in maintaining a desired spacing between two or more discrete clusters of banded individual battery cells.

A system or method according to any embodiment, further comprising a bracket assembly configured to operably couple the at least one cell voltage temperature node to the battery tray.

A system or method according to any embodiment, wherein the bracket assembly is operably coupled to the cell voltage temperature node by at least one of a threaded fastener, rivet, or adhesive.

A system or method according to any embodiment, wherein the bracket assembly includes one or more resilient portions configured to temporarily deform to enable coupling of the discrete cell voltage temperature node to the bracket assembly, and then to spring back to an un-deformed position to inhibit inadvertent decoupling of the bracket assembly from the cell voltage temperature node.

A system or method according to any embodiment, wherein the bracket assembly includes at least one post configured to be received within a corresponding aperture of the cell voltage temperature node.

A system or method according to any embodiment, wherein the bracket assembly includes at least one channel configured to receive a portion of the cell voltage temperature node.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. An electric vehicle battery pack comprising:
a battery tray; and
a plurality of individual battery cells;
one or more bands surrounding at least a portion of the plurality of individual battery cells, thereby banding the portion of individual battery cells together in a discrete cluster; and
a bracket assembly configured to operably couple the banded discrete cluster to the battery tray.

2. The electric vehicle battery pack of claim 1, wherein the electric vehicle battery pack comprises a total of eight rows of banded individual battery cells.

3. The electric vehicle battery pack of claim 1, wherein the discrete clusters each include an end plate configured to absorb stress exerted upon the discrete cluster.

4. The electric vehicle battery pack of claim 1, wherein the bracket assembly is operably coupled to the battery tray by at least one of a threaded fastener, rivet, or adhesive.

5. The electric vehicle battery pack of claim 1, wherein the bracket assembly is integrally formed within the battery tray.

6. The electric vehicle battery pack of claim 1, wherein the bracket assembly is mounted on at least one of a horizontal or vertical surface within the battery tray.

7. The electric vehicle battery pack of claim 1, wherein the bracket assembly includes one or more resilient portions configured to temporarily deform to enable coupling of the discrete cluster to the bracket assembly, and then to spring back to an un-deformed position to inhibit inadvertent decoupling of the bracket assembly from the discrete cluster.

8. The electric vehicle battery pack of claim 1, wherein the one or more bands surrounding at least a portion of the plurality of individual battery cells includes a post, stud or protrusion configured to matingly engage with a portion of the bracket assembly.

9. The electric vehicle battery pack of claim 1, wherein the bracket assembly comprises at least one lateral cross band configured to at least partially traverse around a lateral portion of the discrete cluster of banded individual cells.

10. The electric vehicle battery pack of claim 1, wherein the bracket assembly is configured to aid in maintaining a desired spacing between two or more discrete clusters of banded individual battery cells.

11. An electric vehicle battery pack comprising:
a battery tray; and
at least one cell voltage temperature node; and
a bracket assembly configured to operably couple the at least one cell voltage temperature node to the battery tray.

12. The electric vehicle battery pack of claim 11, wherein the bracket assembly is operably coupled to the cell voltage temperature node by at least one of a threaded fastener, rivet, or adhesive.

13. The electric vehicle battery pack of claim 11, wherein the bracket assembly includes one or more resilient portions configured to temporarily deform to enable coupling of the discrete cell voltage temperature node to the bracket assembly, and then to spring back to an un-deformed position to inhibit inadvertent decoupling of the bracket assembly from the cell voltage temperature node.

14. The electric vehicle battery pack of claim 11, wherein the bracket assembly includes at least one post configured to be received within a corresponding aperture of the cell voltage temperature node.

15. The electric vehicle battery pack of claim 11, wherein the bracket assembly includes at at least one channel configured to receive a portion of the cell voltage temperature node.

16. The electric vehicle battery pack of claim 11, wherein the cell voltage temperature node is operably coupled to the bracket assembly without the use of additional fasteners or adhesives.

17. The electric vehicle battery pack of claim 11, wherein the cell voltage temperature node is operably coupled to the bracket assembly with the aid of a frictional interfering fit.

18. An electric vehicle battery pack comprising:
a battery tray; and
a plurality of individual battery cells;
one or more bands surrounding at least a portion of the plurality of individual battery cells, thereby banding the portion of individual battery cells together in a discrete cluster;
at least one cell voltage temperature node for each banded discrete cluster;
a battery cell bracket assembly configured to operably couple the banded discrete cluster to the battery tray; and
a cell voltage temperature node bracket assembly configured to operably couple the at least one cell voltage temperature node to the battery tray.

19. The electric vehicle battery pack of claim 18, wherein the electric vehicle battery pack comprises a total of eight rows of banded individual battery cells.

20. The electric vehicle battery pack of claim 19, wherein the battery cell bracket assembly and cell voltage temperature node bracket assembly are integrally formed within the battery tray.
